(19) United States
(12) Patent Application Publication
(10) Pub. No.: US 2022/0321972 A1
(43) Pub. Date: Oct. 6, 2022

(54) TRANSMITTING CONTENT BASED ON GENRE INFORMATION

(71) Applicant: Rovi Guides, Inc., San Jose, CA (US)

(72) Inventors: Padmassri Chandrashekar, Bangalore (IN); Daina Emmanuel, Bangalore (IN); Jayshil Parekh, Bengaluru (IN)

(21) Appl. No.: 17/219,270

(22) Filed: Mar. 31, 2021

(51) Int. Cl. H04N 21/482; G06F 40/205; H04N 21/472; H04N 21/64; H04N 21/45

(52) U.S. Cl. CPC H04N 21/4828; G06F 40/205; H04N 21/472; H04N 21/64; H04N 21/4532; H04N 21/44209

(57) ABSTRACT

Systems and methods for transmitting content based on genre information is disclosed. A manifest of a content item is received. The manifest identifies a plurality of segments of the content item. For each segment, the manifest comprises a respective network address and a respective genre. In response to a selection of a first genre, the manifest is parsed to identify that a first segment of the plurality of segments is associated with the first genre and a second segment that follows the first segment in the plurality of segments is associated with a second genre, wherein the second genre is different from the first genre. Data for the first segment is requested from a first network address associated with the first segment and requesting of data for the second segment is skipped. The first segment is displayed based on the data requested from the first network address.

### BACKGROUND

With the rapid development of internet technology and the increased use of online content platforms, numerous online media assets are available to media consumers at their fingertips. However, there may be some technical issues that may disturb consuming of the media asset, for example, limited space availability of a storage device or an unstable or slow network connection.

To address these or other issues, in one existing approach, a system will simply pause downloading the media asset and resume downloading when the space in the storage device becomes available or the network bandwidth increases. This approach is deficient because it may lead to a noticeable latency of the presentation of the media asset or incomplete downloading of the media asset, which prevents the user from thoroughly enjoying the media asset within a reasonable time.

### SUMMARY

To overcome such deficiencies, the methods and systems are described herein for modifying a manifest of a media asset (e.g., content item) to include genre information and requesting only those segments of the content item that are of interest to the user based on genre information. In particular, for each segment of sequential segments of the content item, a type of genre that represents the characteristics of the segment (e.g., “romance” or “comedy”) is inserted into the manifest. The genre information may be used to identify segments of interest that will selectively be downloaded to a user device.

For example, in response to a request for a presentation of the content item (e.g., a request for “Mamma Mia”), a manifest of the content item is transmitted from a media server to a media application implemented on the user device. For each segment of the content item, the manifest includes a) a respective network address (e.g., uniform resource locator) and b) a respective genre. A non-exclusive list of genres includes action, romance, song, sad, fight, dialogue, comedy, mystery, narrative, thriller, horror, or humor. The media application identifies a first genre (e.g., a genre of interest to the user) in various ways. In one example, the media application retrieves user history or downloading pattern and determines that the first genre (e.g., “comedy”) is of interest to the user. In another example, the media application receives a user selection of the first genre through a graphical user interface of the user device specifying a particular genre.

In response to identifying the first genre, the media application parses the manifest to identify a segment that is associated with the identified first genre. It may do so by comparing a genre of a corresponding segment of the content item to the first genre and identifying a matching segment. Once the media application identifies the matching segment that is associated with the first genre, the media application requests data for only the matching segment that is associated with the first genre. The matching segment associated with the first genre is retrieved from a respective network address indicated in the manifest. Once the segment is retrieved, the media application generates the retrieved segment for display (e.g., streaming) at the user device. If the media application determines a certain segment is not associated with the first genre, then the media application skips requesting data for that segment that is not associated with the first genre. Skipping requesting of data for that segment causes a next segment that is associated with the first genre to be displayed on the user device.

In some embodiments, a manifest contains information about bitrate variants. For each segment, multiple bitrate variants (e.g., rates) are available (e.g., 1080p, 720p, 360p), and a bitrate variant will determine a resolution level of a segment. A different resolution level uses a different number of bits per second of bandwidth for transmitting a segment to the user device.

When changing the resolution, the first genre may be used as a parameter in the rate upshift or downshift algorithm. In other words, a genre of interest is used when determining a resolution level of the segment in either upshifting or downshifting. For example, when the first genre is identified as a genre of interest that allows skipping downloading of some segments that are no longer required, a rate upshift algorithm may be used to shift the rate to a higher resolution level than a default resolution level. On the other hand, when the first genre requires downloading of a number of segments that exceed the available network bandwidth, a rate downshift algorithm may be used to shift the rate to a lower resolution level than the default level to allow rendering of all the required segments for display.

A manifest may be specified in any markup language. For example, a manifest is specified in an XML (extensible markup language). To label manifest data, various tags may be used. Specifically, a tag combined with textual information for the genre information may be generated to specify a genre of a segment. For example, an example manifest, e.g., <#EXTINF:9.97667, CURRENT=song fileSequence1.ts>, may indicate that the current segment is associated with a genre tag for “song.” Any functionality or infrastructure may be employed for use with respect to the creation and definition of a genre information tag in a manifest.

In some embodiments, a genre of a future segment is signaled with a genre of a current segment. Specifically, one or more tags combined with additional textual information may be employed to indicate a genre for a future segment. For example, an example manifest, e.g., <#EXTINF:9.97667, CURRENT=song, FUTURE=comedy fileSequence1.ts>, may indicate that the current segment (e.g., segmentl) is associated with a genre tag for “song” and a future segment (e.g., segment 2) is associated with a genre tag for “comedy.” Because a genre of a later segment is signaled with a current segment, it allows the media application to predict a genre for the later segment and determines a resolution level of the future segment ahead of time, allowing predetermination of whether the future segment needs to be downloaded. In some embodiments, genre information of any number of later segments may be signaled with a genre of a current segment.

In some embodiments, one or more genre tags are associated with a single segment due to the overlapping characteristics of the segment. For example, a segment can be funny but romantic at the same time. Then, the segment may be associated with both “comedy” and “romantic” genres. In this example, the manifest may be modified to include the associated tags, such as a first genre tag for “song” and as a second genre tag for “comedy” for segment 1: <#EXTINF:9.97667, CURRENT=song, comedy fileSequence1.ts.>. Any number of genre tags may be employed for a single segment in a manifest.

The present disclosure addresses one or more network issues or limited space issues described above by skipping requesting of data for segments of the content item that are not of interest to the user based on genre information and requesting data for only those segments that match the genre of interest. Thereby, the present disclosure enables the user to consume the media asset within a reasonable time yet still minimizes the use of bandwidth consumption and amount of local storage dedicated to caching and storing the unnecessary segments of the content item.

It should be noted that the systems, methods, apparatuses, and/or aspects described above may be applied to, or used in accordance with, other systems, methods, apparatuses, and/or aspects described in this disclosure.

### DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 depicts an illustrative block diagram of a system for selective downloading of content based on genre information, in accordance with some embodiments of the disclosure;

FIG. 2 depicts an illustrative block diagram showing additional details of the system for selective downloading of content based on genre information, in accordance with some embodiments of the disclosure;

FIG. 3 depicts an exemplary user interface for providing a list of genres for display on the illustrative device, in accordance with some embodiments of the disclosure;

FIG. 4 depicts an exemplary user interface for downloading segments associated with selected genres on an illustrative device, in accordance with some embodiments of the disclosure;

FIG. 5 depicts an exemplary user interface for displaying segments associated with selected genres on an illustrative device, in accordance with some embodiments of the disclosure;

FIG. 6 depicts a flowchart of a process for selective downloading of content based on genre information, in accordance with some embodiments of the disclosure;

FIG. 7 depicts a flowchart of a process for selective downloading of content based on tag values, in accordance with some embodiments of the disclosure;

FIG. 8 depicts a block diagram of an exemplary manifest including genre information, in accordance with some embodiments of the disclosure;

FIG. 9 depicts a block diagram of an exemplary manifest including genre information for a subsequent segment, in accordance with some embodiments of the disclosure; and

FIG. 10 depicts an exemplary manifest markup language including gerne information, in accordance with some embodiments of the disclosure.

### DETAILED DESCRIPTION

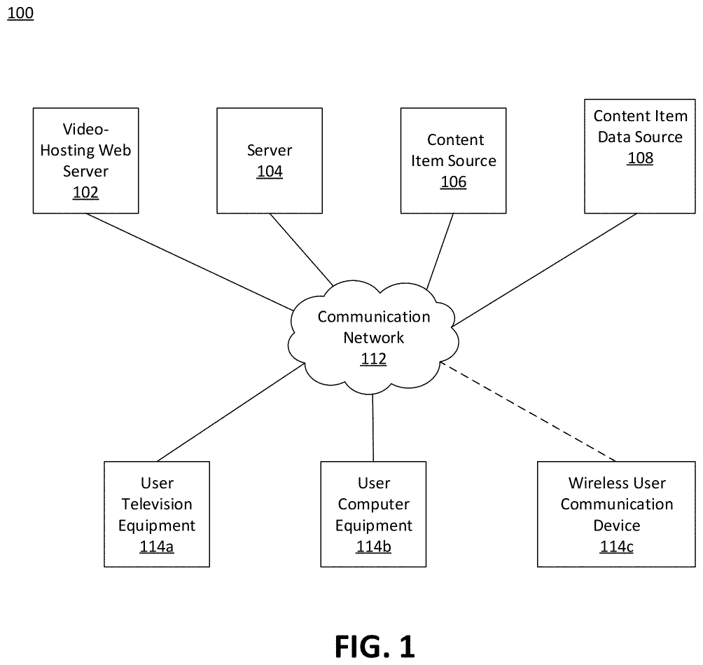

FIG. 1 shows an illustrative block diagram of a system 100 for selective downloading of content based on genre information, in accordance with some embodiments of the disclosure. In one aspect, system 100 includes one or more of video-hosting web server 102, server 104, content item source 106, content item data source 108, and communication network 112.

Communication network 112 may be one or more networks including the Internet, a mobile phone network, mobile voice or data network (e.g., a 4G or LTE network), cable network, public switched telephone network, or other types of communication network or combinations of communication networks. Communication network 112 includes one or more communication paths, such as a satellite path, a fiber-optic path, a cable path, a path that supports Internet communications (e.g., IPTV), free-space connections (e.g., for broadcast or other wireless signals), or any other suitable wired or wireless communication path or combination of such paths. Communication network 112 communicatively couples various components of system 100 to one another. For instance, server 104 may be communicatively coupled to video-hosting web server 102, content item source 106, and/or content item data source 108 via communication network 112.

Video-hosting web server 102 hosts one or more video websites, such as YouTube™, and/or the like, that enable users to download or stream videos, video clips, and/or other types of content. In addition to enabling users to download and view content, the video websites also provide access to data regarding downloaded content.

Content item source 106 may include one or more types of content distribution equipment including a television distribution facility, cable system headend, satellite distribution facility, programming sources (e.g., television broadcasters, such as NBC™, ABC™, HBO™ etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc.

Content item source 106 may be the originator of content (e.g., a television broadcaster, a Webcast provider, etc.) or may not be the originator of content (e.g., an on-demand content provider, an Internet provider of content of broadcast programs for downloading, etc.). Content item source 106 may include cable sources, satellite providers, on-demand providers, Internet providers, over-the-top content providers, or other providers of content. Content item source 106 may also include a remote media server used to store different types of content (e.g., including video content selected by a user) in a location remote from computing device 114 (described below). Systems and methods for remote storage of content and providing remotely stored content to user equipment are discussed in greater detail in connection with Ellis et al., U.S. Pat. No. 7,761,892, issued Jul. 20, 2010, which is hereby incorporated by reference herein in its entirety.

Content item data source 108 may provide content item-related data, such as the manifest or metadata of the content item described herein, to computing device 114, server 104 and/or video-hosting web server 102 using any suitable approach. The manifest of the content item may include, among other information of the content item, genre information for each segment of the content item. In one example, the manifest may be an MPEG-DASH manifest. In some embodiments, content item source 106 and content item data source 108 may be integrated as one device.

In some embodiments, content item data from content item data source 108 may be provided to computing device 114 using a client/server approach. For example, computing device 114 may pull content item data from a server (e.g., server 104), or a server may push content item data to computing device 114. In some embodiments, a client application residing on computing device 114 may initiate sessions with content item data source 108 to obtain content item data when needed, e.g., when the content item data is out of date or when computing device 114 receives a request from the user to receive data.

Content and/or content item data delivered to computing device 114 may be over-the-top (OTT) content. OTT content delivery allows Internet-enabled user devices, such as computing device 114, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YouTube™, Netflix™, and HULU, which provide audio and video via IP packets. YouTube™ is a trademark owned by Google Inc., Netflix™ is a trademark owned by Netflix Inc., and Hulu is a trademark owned by Hulu, LLC. OTT content providers may additionally or alternatively provide content item data described above. In addition to content and/or content item data, providers of OTT content can distribute applications (e.g., web-based applications or cloud-based applications), or the content can be displayed by applications stored on computing device 114.

As described in further detail below, server 104 accesses the content of the video website(s) hosted by video-hosting web server 102 and, based on the accessed content, generates a variety of types of data such as metadata or manifest (e.g., terms, associations between terms and corresponding media content identifiers, genre information for each segment of the content item, and/or the like) that can be accessed to facilitate the retrieving or searching of media content made available by content item source 106. In some embodiments, server 104 accesses a manifest or metadata of the content item from content item data source 108. The manifest of the content item may be generated by video-hosting web server 102 or server 104. In some embodiments, the manifest of the content item may be generated by a third-party generator who has access to the content item.

System 100 also includes one or more computing devices 114, such as user television equipment 114a (e.g., a set-top box), user computer equipment 114b, and wireless user communication device 114c (e.g., a smartphone device or a remote control), which users can use to interact with server 104, content item data source 108, and/or content item source 106, via communication network 112, to search for desired media content. For instance, in some aspects, server 104 may provide a user interface via computing device 114, by which a user can input a query for a particular item of media content made available by content item source 106, and generate a response to the query by accessing and/or processing data and/or metadata. Although FIG. 1 shows one of each component, in various examples, system 100 may include multiples of one or more illustrated components. For instance, system 100 may include multiple video-hosting web servers 102 and server 104 may aggregate data from the multiple video websites hosted by multiple video-hosting web servers 102, respectively.

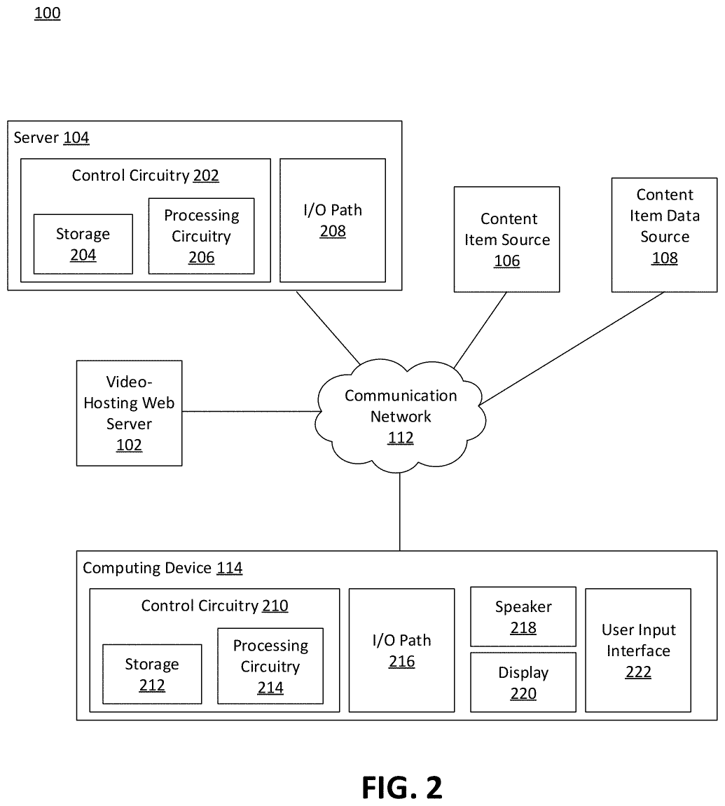

FIG. 2 is an illustrative block diagram showing additional details of the system 100 for selectively downloading segments of a content item based on genre information FIG. 1, in accordance with some embodiments of the disclosure. In particular, server 104 includes control circuitry 202 and Input/Output (I/O) path 208, and control circuitry 202 includes storage 204 and processing circuitry 206. Computing device 114 includes control circuitry 210, I/O path 216, speaker 218, display 220, and user input interface 222. Control circuitry 210 includes storage 212 and processing circuitry 214. Control circuitry 202 and/or 210 may be based on any suitable processing circuitry such as processing circuitry 206 and/or 214.

As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors, for example, multiple of the same type of processors (e.g., two Intel Core i9 processors) or multiple different processors (e.g., an Intel Core i7 processor and an Intel Core i9 processor).

Each of storage 204, storage 212, and/or storages of other components of system 100 (e.g., storages of content item source 106, content item data source 108, and/or the like) may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Each of storage 204, storage 212, and/or storages of other components of system 100 may be used to store various types of content, content item data, and or other types of data. Non-volatile memory may also be used (e.g., to launch a boot-up routine and other instructions). Cloud-based storage may be used to supplement storages 204, 212 or instead of storages 204, 212.

In some embodiments, control circuitry 202 and/or 210 executes instructions for an application stored in memory (e.g., storage 204 and/or 212). Specifically, control circuitry 202 and/or 210 may be instructed by the application to perform the functions discussed herein. In some implementations, any action performed by control circuitry 202 and/or 210 may be based on instructions received from the application. For example, the application may be implemented as software or a set of executable instructions that may be stored in storage 204 and/or 212 and executed by control circuitry 202 and/or 210. In some embodiments, the application may be a client/server application where only a client application resides on computing device 114, and a server application resides on server 104.

The application (e.g., media application) may be implemented using any suitable architecture. For example, it may be a stand-alone application wholly implemented on computing device 114. For example, the media application may be implemented as software or a set of executable instructions, which may be stored in non-transitory storage 212 and executed by control circuitry 210 of a user device 114. In such an approach, instructions for the application are stored locally (e.g., in storage 212), and data for use by the application is downloaded on a periodic basis (e.g., from an out-of-band feed, from an Internet resource, or using another suitable approach). Control circuitry 210 may retrieve instructions for the application from storage 212 and process the instructions to perform the functionality described herein. Based on the processed instructions, control circuitry 210 may determine what action to perform when input is received from user input interface 222.

In client/server-based embodiments, control circuitry 210 may include communication circuitry suitable for communicating with an application server (e.g., server 104) or other networks or servers. The instructions for carrying out the functionality described herein may be stored on the application server. Communication circuitry may include a cable modem, an integrated services digital network (ISDN) modem, a digital subscriber line (DSL) modem, a telephone modem, an Ethernet card, or a wireless modem for communication with other equipment, or any other suitable communication circuitry. Such communication may involve the Internet or any other suitable communication networks or paths (e.g., communication network 112).

In another example of a client/server-based application, control circuitry 210 runs a web browser that interprets web pages provided by a remote server (e.g., server 104). For example, the remote server may store the instructions for the application in a storage device. The remote server may process the stored instructions using circuitry (e.g., control circuitry 202) and generate the displays discussed above and below. Computing device 114 may receive the displays generated by the remote server and may display the content of the displays locally via display 220. This way, the processing of the instructions is performed remotely (e.g., by server 104) while the resulting displays are provided locally on computing device 114. Computing device 114 may receive inputs from the user via input interface 222 and transmit those inputs to the remote server for processing and generating the corresponding displays.

A user may send instructions to control circuitry 202 and/or 210 using user input interface 222. User input interface 222 may be any suitable user interface, such as a remote control, trackball, keypad, keyboard, touchscreen, touchpad, stylus input, joystick, voice recognition interface, or other user input interfaces. User input interface 222 may be integrated with or combined with display 220, which may be a monitor, a television, a liquid crystal display (LCD), electronic ink display, or any other equipment suitable for displaying visual images.

Server 104 and computing device 114 may receive content and data via I/O paths 208 and 216, respectively. I/O paths 208, 216 may provide content (e.g., broadcast programming, on-demand programming, Internet content, content available over a local area network (LAN) or wide area network (WAN), and/or other content) and data to control circuitry 202, 210. Control circuitry 202, 210 may be used to send and receive commands, requests, and other suitable data using I/O paths 208, 216. I/O paths 208, 216 may connect control circuitry 202, 210 (and specifically processing circuitry 206, 214) to one or more communication paths (described below). I/O functions may be provided by one or more of these communication paths but are shown as single paths in FIG. 2 to avoid overcomplicating the drawing.

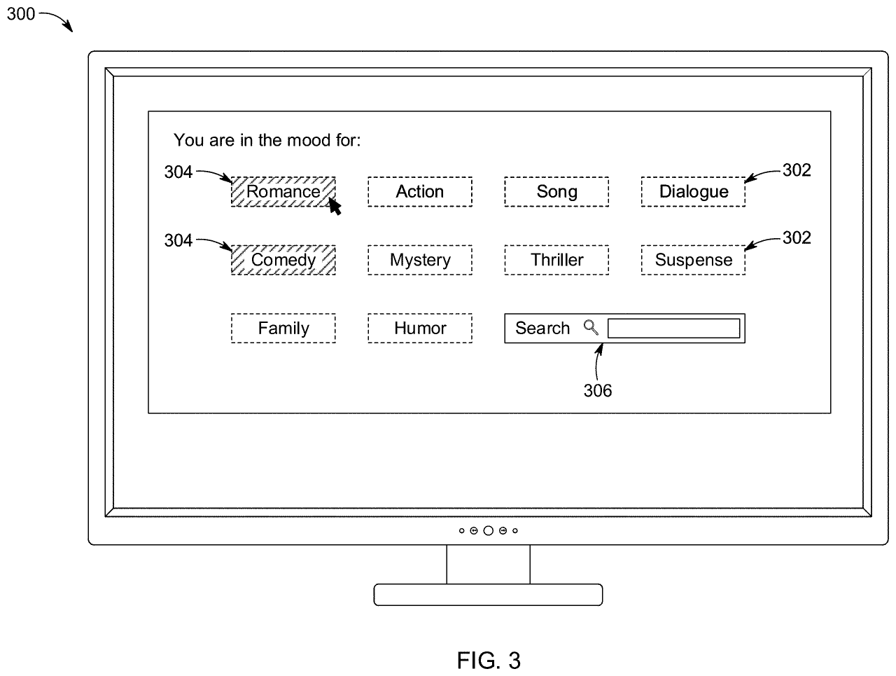

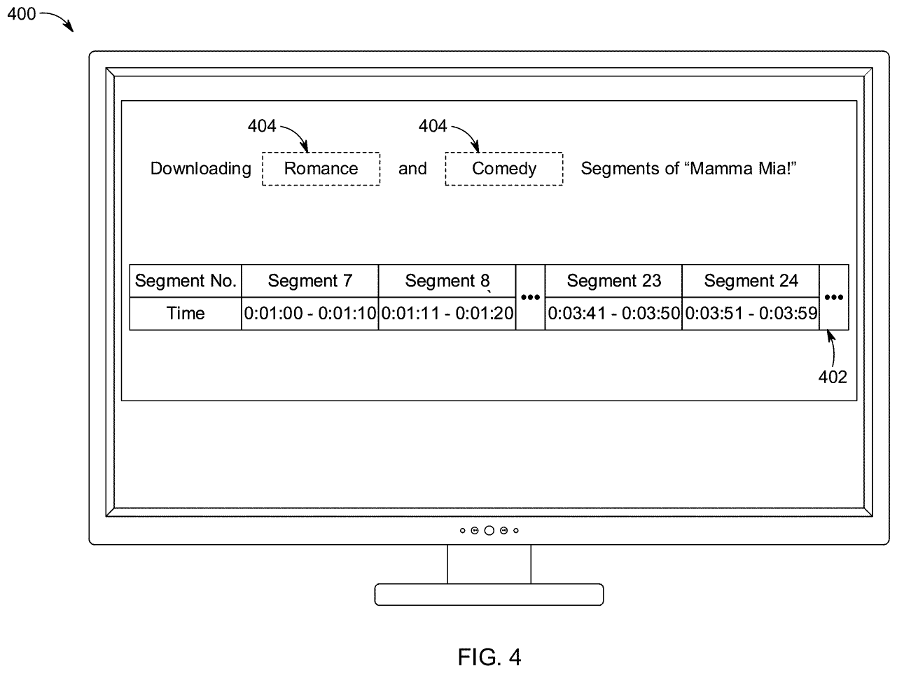

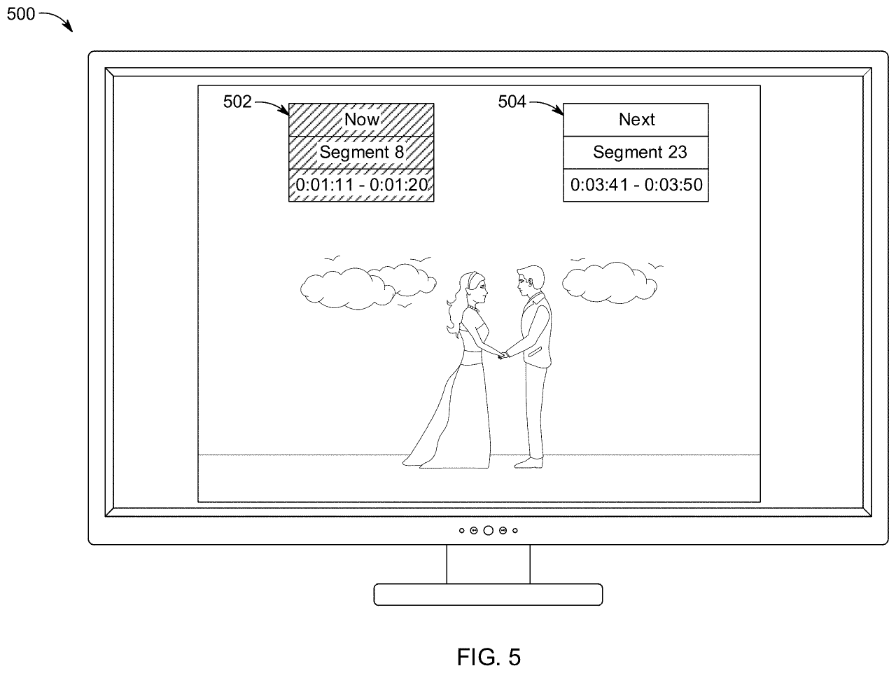

Having described system 100, reference is now made to FIG. 3, which depicts an example user interface 300 for providing a list of genres for display on the illustrative device that may be implemented using system 100, in accordance with some embodiments of the disclosure. Reference is also made to FIG. 4 and FIG. 5, which show example user interfaces 400, 500 generated by system 100, in accordance with some embodiments. Although FIGS. 3-5 depict a user device (e.g., display device) as a television, it will be understood that any suitable device for displaying video content may be used, such as gaming equipment, user computer equipment, or a wireless user communications device discussed above in relation to FIG. 1.

The user device may have control circuitry 202, 210 of FIG. 2 configured to request the video content of the content item from a server for display. The content item includes a group of sequential segments. Each segment consists of one or more frames, where the length of each segment ranges approximately from zero to a few seconds (e.g., 0-10 seconds). In some embodiments, a frame is one of the many still images that compose a segment of the content item. It will be understood that, consistent with the present disclosure, any content item may be requested for streaming or downloading from server 104 or video-hosting web server 102.

As referred to herein, the term “content item” should be understood to mean an electronically consumable user asset, such as an electronic version of a printed book, electronic television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, articles, newspapers, blogs, advertisements, chat sessions, social media, applications, games, and/or any other media or multimedia and/or combination of the same.

When a user requests a presentation of a content item (e.g., “Mamma Mia”) on computing device (e.g., TV or laptop) 114 via the media application, the media application requests the content item from video-hosting web server 102 or server 104. In response to the request, the server sends a manifest of the content item. The manifest contains information about sequential segments of the content item, for example, timing of each segment such as a time period for each segment, location on the network such as a network address from where each segment can be retrieved, or genre information for each segment. In some embodiments, the manifest may be an MPEG-DASH manifest.

As shown in exemplary user interface 300, the media application may generate a list of genres 302-304 based on the received manifest. List of genres 302-304 includes one or more available genres that are associated with at least one segment of the content item. Each genre in the list represents a respective category that involves particular characteristics that distinguish it from the other categories. A non-exclusive list of genres includes action, romance, song, sad, fight, dialogue, comedy, mystery, narrative, thriller, horror, or humor.

In one embodiment, list of genres 302-304 is generated for display before receiving the manifest. In this embodiment, list of genres 302-304 is generated using the most popular or most searched genres based on user history or patterns. In some embodiments, exemplary user interface 300 includes a search bar 306 that allows a user to type in or search for a genre that is not listed in exemplary user interface 300.

As shown in FIG. 3, exemplary user interface 300 includes a question or statement, e.g., “You are in the mood for:” that prompts the user to select at least one of the presented graphical user interface elements (e.g., buttons) associated with respective genres. For example, each button represents a respective genre of the content item, such as “comedy,” “thriller,” or “romance.” If a user is feeling sad and wants to watch “comedy” parts of the movie “Mamma Mia,” then the user can simply choose a “comedy” button presented on exemplary user interface 300 using user input interface 222.

As shown in FIG. 3, a user can select more than one genre at a time. As shown by greyed buttons 304, “romance” and “comedy” genres are selected as these buttons appear visually distinguishable from the unselected buttons 302, such as “suspense” or “dialogue.” Any combination of genres may be selected.

FIG. 4 depicts an exemplary user interface 400 for downloading segments associated with selected genres. Upon receiving a user selection of “comedy” and “romance,” the media application parses the manifest to identify segments associated with the selected genres. In one embodiment, the media application identifies segments that are associated with at least one of the selected genres, either “comedy” or “romance,” using an “OR” logic operation. Accordingly, any segment that is associated with either one (does not have to be both) is identified to be related to the user input. In another embodiment, the media application identifies segments that are associated with both of the selected genres, “comedy” and “romance,” using an “AND” logic operation. Accordingly, only a segment associated with both “comedy” and “romance” is identified to be related to the user input. The logic operation may comprise system-configurable or user-configurable parameters that can be modified in the setting.

In some embodiments, a segment is associated with one or more genres that are different from one another due to the overlapping characteristics of the segment. For example, a segment can be funny but romantic at the same time. Then, the segment may be associated with both “comedy” and “romantic” genres. Although a combination of “comedy” and “romantic” is used herein, any combination of the non-exclusive list of genres may be used.

In some embodiments, the media application compares the received user input specifying a genre (e.g., romance) to genre information of each segment of the plurality of segments of the content item. Upon determining a match, the media application displays segment information that matches the selected genre in FIG. 4. For example, “Mamma Mia” includes four romance or comedy segments: segment 7, segment 8, segment 23, and segment 24. As shown in the exemplary user interface 400, the segment information matching the selected genre is displayed. For example, a time period for segment 7 is from 0:01:00 to 0:01:10 (ten seconds), and a time period for segment 8 that follows segment 7 in the plurality of segments of the content item is from 0:01:11 to 0:01:20 (ten seconds). The next segment that matches the selected genre is segment 23, and there is a 2-minute-and-20-second gap between segment 8 and segment 23. These are just example segment parameters, and any suitable parameters or variations may be used for each segment of the content item.

Once segments are identified, the media application downloads the identified segments to the user device from respective network addresses. For example, the manifest of the content item includes a respective network address from where a corresponding segment can be retrieved. The network address may be a link or a uniform resource locator (URL) address to the segment. Based on the network address information included in the manifest, the media application requests data for segment 7 from a network address associated with segment 7. The data for segment 7 may be retrieved from a database of content such as content item source 106 or content item data source 108. The retrieved segment 7 is transmitted to computing device 114 for display. The transmitted data may be stored in a cache or storage 212 of computing device 114. Once data retrieval is completed for segment 7, the media application may perform the same process for segment 8 as segment 8 is also identified to be associated with the “comedy” or “romance” genres.

On the other hand, the media application may skip requesting data for segment 9 since segment 9 is identified to be not related to “comedy” or “romance” genres. To save the network bandwidth or to secure space in storage 212, the media application will not request data for segment 9. As a result, a storage space dedicated to segment 9 becomes available for other necessary segments that need to be downloaded. The media application may perform the same process of skipping requesting of data until segment 23, which is identified to be related to the selected genres of “romance” or “comedy.”

The media application resumes requesting data for segment 23, as segment 23 is identified to be associated with “romance” or “comedy” genres. The media application may request data for segment 23 from a network address associated with segment 23. The data for segment 23 is transmitted to computing device 114. Skipping of unrelated segments 9-22 causes segment 23 to be displayed after displaying segment 8.

FIG. 5 depicts an exemplary user interface 500 for displaying segments associated with selected genres on an illustrative device, in accordance with some embodiments of the disclosure. Exemplary user interface 500 may be the resulting view of downloading only “romance” or “comedy” segments of the movie “Mamma Mia.” For example, segment 8 is presented on a display of computing device 114. Segment 8 may be presented with segment information 502. In some embodiments, the segment information includes timing information, including a start time (e.g., 0:01:11) and an end time (e.g., 0:01:20), and segment identification (e.g., segment 8). As shown in FIG. 5, segment information 502 is highlighted to indicate that segment 8 is currently being displayed. Exemplary user interface 500 may also include segment information 504 for a subsequent segment that is associated with the user selection. In connection with FIG. 4, segment 23 is the next segment that is associated with “romance” or “comedy” genres. Therefore, segment 23 will be displayed immediately after displaying segment 8, even though there is a time gap in the original content item.

Although a download operation is described herein for simplicity, any operation related to a presentation of the content item is available. For example, the content item may be available for streaming or available for high-resolution display. In one example, the content item may be streamed in real time for a presentation instead of downloading the content item in storage 212 of computing device 114. In another example, the segment may be downloaded at a quality level that is higher (e.g., high resolution) than a default quality level (e.g., standard resolution). A higher-quality-level segment may include a higher number of bits than the default-quality-level segment. In one example, the higher-quality-level segment may have a higher frame rate than the default-quality-level segment. In another example, the higher-quality-level segment may allocate a higher number of pixels than the default-quality-level segment. In some embodiments, a user-selectable element associated with a corresponding operation (e.g., streaming, downloading, recording, storing, downloading at a high resolution) may be presented when the user requests the content item for display. Based on the user input selecting an operation, a corresponding action may be performed.

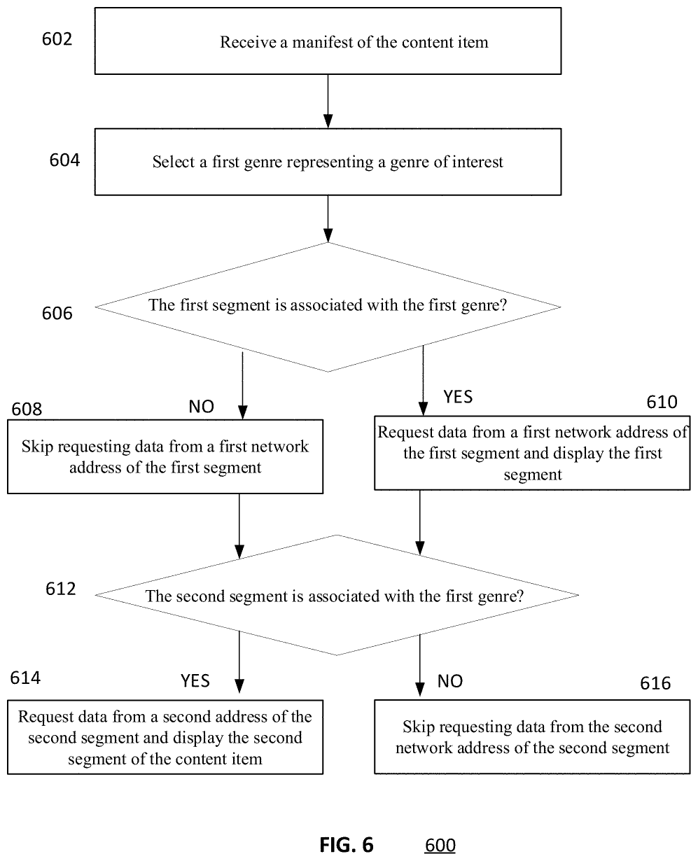

FIG. 6 depicts a flowchart of a process 600 for selective downloading of content based on genre information, in accordance with some embodiments of the disclosure. It should be noted that process 600 may be performed by control circuitry 202, 210 of FIG. 2 as instructed by a media application that may be performed on any device 114 of FIG. 2. In addition, one or more steps of process 600 may be incorporated into or combined with one or more embodiments (e.g., user interface 300 of FIG. 3, user interface 400 of FIG. 4, and user interface 500 of FIG. 5). The process 600 may be performed in accordance with the components discussed in connection with FIGS. 1-2.

The user may request a presentation of a content item (e.g., “Mamma Mia”) via a media application on computing device 114. The content item consists of one or more segments, where each segment is associated with a respective genre. In response to the request, at step 602, control circuitry 210 receives a manifest of the content item from a media server (e.g., server 104 or video-hosting web server 102). The manifest contains information about sequential segments of the content item, for example, timing of each segment, location on the network such as a network address from where each segment can be retrieved, or genre information for each segment.

Genre information indicates a specific genre of a segment (e.g., horror). A segment may be associated with one or more genres based on the characteristics of the segment. Based on the manifest, control circuitry 210 identifies a plurality of segments of the content item. For example, control circuitry 210 identifies at least a) a first segment and at least one associated genre and b) a second segment that follows the first segment and at least one associated genre.

At step 604, control circuitry 210 selects a first genre 304 from a plurality of genres where the first genre 304 represents a genre of interest. In some embodiments, control circuitry 210 retrieves user history or pattern of the selection of one or more genres. Based on the user history, control circuitry 210 identifies user's preferred genre (e.g., comedy) as first genre 304.

In some embodiments, the control circuitry 210 receives a user selection of first genre 304 from a list of genres 302 that is presented on display 220 of computing device 114. The user selection represents the user's preference indicating that the user wishes to watch only segments associated with the selected genre. As shown in exemplary user interface 300, a user selection of a first genre (e.g., comedy) is received through user input interface 222 of computing device 114.

In one embodiment, the presentation of the list of genres is generated based on detecting a change of network bandwidth. For example, control circuitry 210 determines that the network bandwidth has changed over time in that current network bandwidth will not afford presentation of the entire content item at a default quality level or a high quality level. To save the network bandwidth while still being able to present the content item to the user, control circuitry 210 presents the list of genres for a user selection, which will enable downloading or streaming only the necessary segments of the content item rather than transmitting the entire content item.

In another embodiment, the presentation of the list of genres is generated based on detecting a change of space availability in a storage device. For example, control circuitry 210 determines that storage 212 of computing device does not have enough space to download the entire content item. To secure the space availability while still being able to present the content item to the user, control circuitry 210 presents the list of genres for a user selection, which will enable downloading or streaming only the necessary segments of the content item rather than transmitting the entire content item.

At step 606, control circuitry 210 determines whether a first segment of the plurality of segments is associated with the received first genre. If it is determined that a genre associated with the first segment matches the selected first genre, then control circuitry 210 requests data for the first segment at step 610 from a network address for the first segment. The data for the first segment is retrieved from a database of segments such as a content item source 106 or content item data source 108 and transmitted to computing device 114 for display. If it is determined that a genre associated with the first segment does not match the selected first genre, then control circuitry 210 skips requesting of data for the first segment at step 608. The skipped first segment will not be presented for display.

At step 612, control circuitry 210 determines whether a second segment that follows the first segment in the plurality of segments is associated with the selected first genre. If it is determined that a genre associated with the second segment matches the selected first genre, then control circuitry 210 requests data for the second segment at step 614 from a network address for the second segment. The data for the second segment is retrieved from the database of segments and transmitted to computing device 114 for display. If it is determined that a genre associated with the second segment does not match the selected first genre, then control circuitry 210 skips requesting of data for the second segment at step 616. The skipped second segment will not be presented for display.

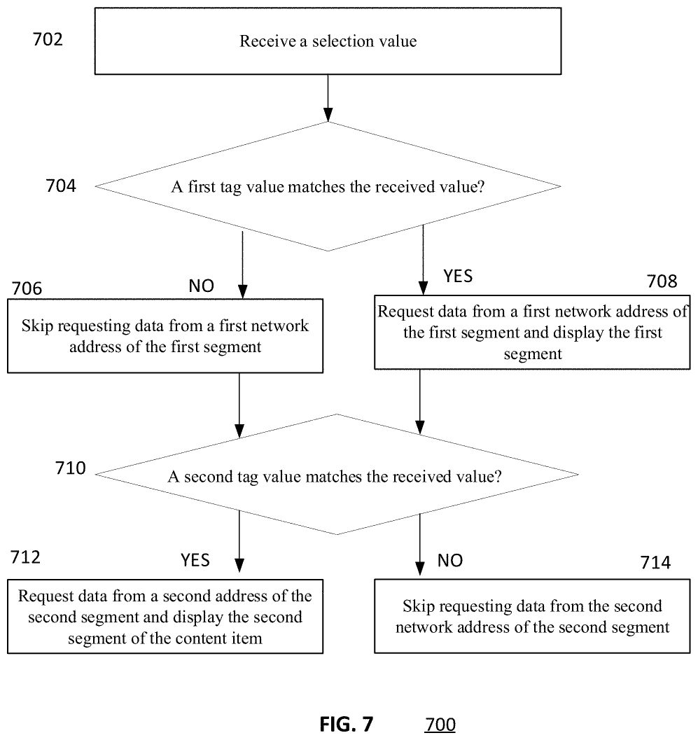

FIG. 7 depicts a flowchart of a process 700 for selective downloading of content based on tag values, in accordance with some embodiments of the disclosure. It should be noted that process 700 may be performed by control circuitry 202, 210 of FIG. 2 as instructed by a media application that may be performed on any device 114 of FIG. 2. In addition, one or more steps of process 700 may be incorporated into or combined with one or more embodiments (e.g., user interface 300 of FIG. 3, user interface 400 of FIG. 4, and user interface 500 of FIG. 5, flow chart 600 of FIG. 6). The process 700 may be performed in accordance with the components discussed in connection with FIGS. 1-2.

In response to a request for a content item, control circuitry 210 receives a manifest of a content item from a media server. The manifest contains information about sequential segments of the content item, such as tag values or bitrate variants. Various tags are utilized to label manifest data in various manners. In some embodiments, the manifest is modified by tagging a genre value corresponding to a respective genre to a segment. For example, the information structure of the manifest is modified such that each segment of the sequential segments includes a respective genre value (e.g., tag value). In some embodiments, a segment may include more than one tag value when the segment is associated with more than one genre. In this case, the tag values are different from one another. The modification may be made by at least one of server 104, video-hosting web server 102, or a third-party generator.

At step 702, control circuitry 210 receives a selection value indicative of a particular genre. Control circuitry 210 parses the manifest to identify a first tag value associated with a first segment of the plurality of segments of the content item and identify a second tag value associated with a second segment of the plurality of segments of the content item. The first tag value is representative of a first genre associated with the first segment. The second tag value is representative of a second genre associated with the second segment. The second tag value is different from the first value.

At step 704, control circuitry 210 determines whether the received selection value matches the first tag value by comparing the received selection value to the first tag value. If it is determined that the received selection value matches the first tag value, then control circuitry 210 requests data for the first segment at step 708. The data for the first segment is retrieved from the first network address and transmitted to computing device 114 for display. If it is determined that the first tag value does not match the received selection value, then control circuitry 210 skips requesting of data for the first segment at step 706. The skipped first segment will not be presented for display.

At step 710, control circuitry 210 determines whether the received value matches the second tag value. If it is determined that the received value matches the second tag value, then control circuitry 210 requests data for the second segment at step 712. The data for the second segment is retrieved from the second network address and transmitted to computing device 114 for display. If it is determined that the second tag value does not match the received value, then control circuitry 210 skips requesting of data for the second segment at step 714. The skipped second segment will not be presented for display.

In some embodiments, control circuitry 210 retrieves user history or pattern of the selection of a genre. Based on the user history, control circuitry 210 identifies one or more genre values that correspond to user's preferred genres (e.g., comedy). Control circuitry 210 skips requesting of data for a segment if a tag value of the segment does not match with the identified genre values. Control circuitry 210 retrieves only the segments that match the identified genre values and presents the segments for display.

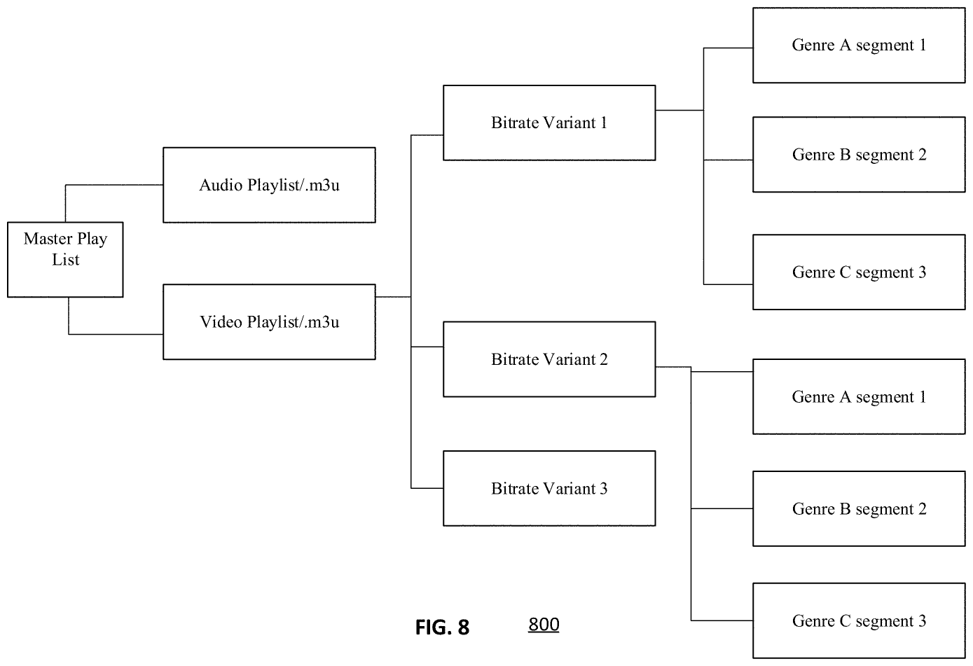

FIG. 8 depicts a block diagram of an exemplary manifest 800, including genre information, in accordance with some embodiments of the disclosure. A manifest includes a master manifest (e.g., master playlist) and multiple rendition manifests. The master manifest indicates an audio playlist (audio playlist/.m3u) and a video playlist (video playlist/.m3u). The video playlist indicates various renditions, such as bitrate variants. For example, the bitrate variants include 1080p rendition, 720p rendition, 360p rendition. A segment of the content item is available for each bitrate variant. For example, segment 1 is available in 1080p rendition, 720p rendition, and 360p rendition. Each rendition manifest includes information about a number of bits that are required to render a segment and a respective link to the segment.

As shown in exemplary manifest 800, a genre type (e.g., song) is tagged to a segment. For example, genre A (e.g., song) is tagged to segment 1, and genre B (e.g., dialogue) is tagged to segment 2. Segment 1, which is associated with genre A, is available for each bitrate variant indicated in the video playlist. While multiple bitrate variants are available for each segment, the master playlist picks the best bitrate variant based on the bandwidth availability.

In one embodiment, a selection of a genre is used as a parameter in the rate upshift or downshift algorithm. For example, when a selection of a particular genre is received, a rate upshift algorithm may be used to shift the rate to a higher resolution level than a default resolution level. On the other hand, when a selection of a particular genre requires downloading of segments that exceed the available bandwidth, a rate downshift algorithm may be used to shift the rate to a lower resolution level than the default level to allow rendering of all the required segments for display. In some embodiments, a more confined and smaller set of genres is available at a higher resolution, and a more granular and larger set of genres is available at a lower resolution.

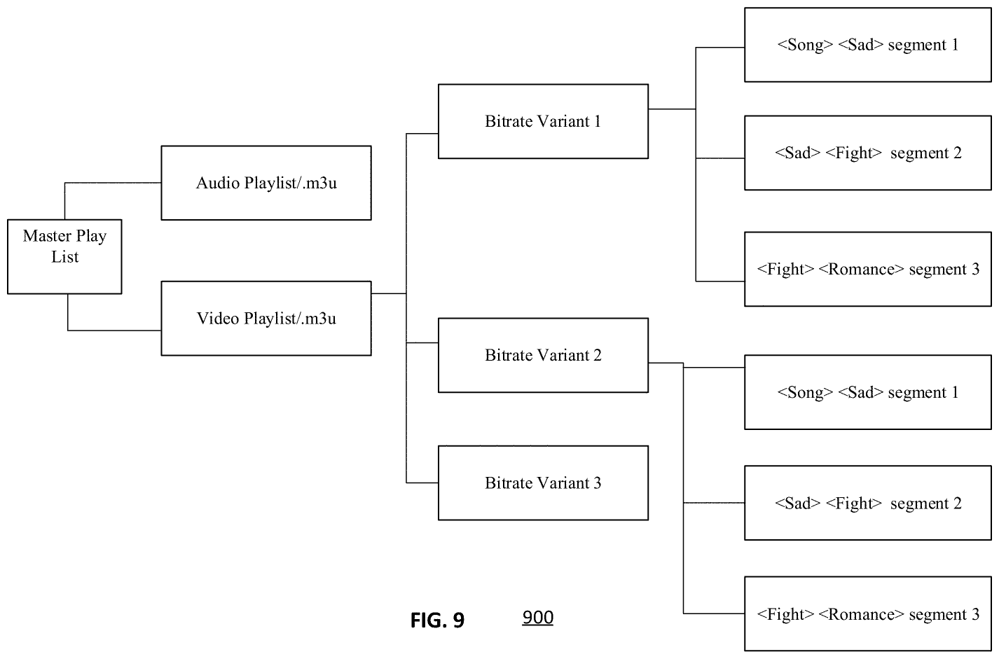

FIG. 9 depicts a block diagram of an exemplary manifest 900, including genre information for a subsequent segment, in accordance with some embodiments of the disclosure. For example, a genre of a future segment is signaled with a genre of the current segment. As shown in exemplary manifest 900, a genre of segment 2 (e.g., sad), which follows segment 1, is signaled with a genre of segment 1 (e.g., song). Also, a genre of segment 3 (e.g., fight), which follows segment 2, is signaled with a genre of segment 2 (e.g., sad). Although exemplary manifest 900 shows a genre of a segment subsequent to the current segment, genres of one or more later segments (i.e., segments that follows the current segment) may be signaled with the current segment. Because a genre of a later segment is signaled with the current segment, the media application predicts genre information for the later segment and determines a resolution level of the later segment ahead of time.

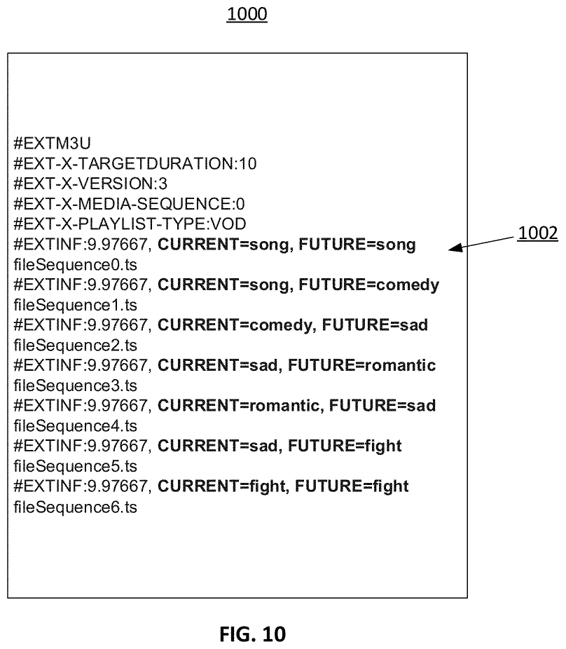

FIG. 10 depicts an exemplary manifest 1000, including genre information, in accordance with some embodiments of the disclosure. Any markup language may be used for employing a manifest, including an XML (extensible markup language) based language. In some embodiments, various tags are utilized to label manifest data in various manners. As shown in FIG. 10, exemplary manifest 1000 includes various information about the content item, such as duration, version, sequence of segments, or type of video (e.g., VOD). Specifically, exemplary manifest 1000 is modified to include genre information for segments in the form of genre tags. For example, an example manifest for segment 1<#EXTINF:9.97667, CURRENT=song, FUTURE=comedy fileSequence1.ts> shows that a genre tag for “song” is employed to indicate that the current segment (segment 1) is associated with a song genre and that a genre tag for “comedy” is employed to indicate that the future segment (segment 2) is associated with a comedy genre. As shown in exemplary manifest 1000, the textual information for genre tags 1002 indicating genre information for segments is inserted into a manifest to specify a genre for each segment.

In some embodiments, one or more genre tags are associated with a single segment due to the overlapping characteristics of the segment. For example, a segment can be funny but romantic at the same time. Then, the segment may be associated with both “comedy” and “romantic” genres. In this example, the manifest may be modified to include the associated tags, such as a first genre tag for “song” and as a second genre tag for “comedy” for segment 1: <#EXTINF:9.97667, CURRENT=song, comedy fileSequence1.ts.>. Any number of genre tags may be employed for a single segment in a manifest. Any functionality or infrastructure may be employed for use with respect to the creation and definition of a genre information tag in a manifest.

The systems and processes discussed above are intended to be illustrative and not limiting. One skilled in the art would appreciate that the actions of the processes discussed herein may be omitted, modified, combined, and/or rearranged, and any additional actions may be performed without departing from the scope of the invention. More generally, the above disclosure is meant to be exemplary and not limiting. Only the claims that follow are meant to set bounds as to what the present disclosure includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
receiving a manifest of a content item, wherein the manifest identifies a plurality of segments of the content item,
wherein for each segment of the plurality of segments, the manifest comprises:
(a) a respective network address; and
(b) a respective genre;
selecting a first genre from a plurality of genres, the first genre representing a genre of interest;
in response to selecting the first genre:
parsing the manifest to identify that a first segment of the plurality of segments is associated with the first genre and that a second segment that follows the first segment in the plurality of segments is associated with a second genre, wherein the second genre is different from the first genre;
requesting data for the first segment from a first network address associated with the first segment;
skipping requesting of data for the second segment from a second network address associated with the second segment;
generating the first segment for display based on the data requested from the first network address; and
generating for display a segment information field corresponding with the first segment for display based on and including the data requested from the first network address.

2. The method of claim 1, wherein selecting the first genre comprises receiving a user selection of the first genre from the plurality of genres.

3. The method of claim 1, wherein selecting the first genre is based at least in part on user profile data.

4. The method of claim 1, wherein the second segment is not associated with the first genre.

5. The method of claim 1, further comprising:
identifying a third segment that follows the second segment in the plurality of segments;
identifying that the third segment is associated with the first genre and the second genre; and
requesting data for the third segment from a third network address associated with the third segment,
wherein skipping requesting of data for the second segment causes the third segment to be displayed after generating the first segment for display.

6. (canceled)

7. The method of claim 1, wherein the first segment is displayed at a higher resolution than a default resolution.

8. The method of claim 1, further comprising:
determining a list of genres that is available for the content item based on the manifest; and
presenting the list of genres for display.

9. The method of claim 8, wherein the list of genres comprises at least one of action, romance, song, sad, fight, dialogue, comedy, mystery, narrative, thriller, horror, or humor.

10. The method of claim 8, wherein presenting the list of genres for display is based at least in part on detecting a change of bandwidth availability or a change of availability in a storage device.

11. A method comprising:
identifying, by a server, a plurality of segments of a content item;
transmitting, by the server, a manifest of the content item to a client computing device over a communication network,
wherein for each segment of the plurality of segments, the manifest comprises:
(a) a respective network address; and
(b) a respective genre;
receiving, at the server, a first request for data for a first segment of the plurality of segments from the client computing device;
retrieving, by the server, the data for the first segment from a database of segments;
transmitting the data for the first segment to the client computing device over the communication network;
generating the first segment for display based on the data requested from the respective network address; and
generating for display a segment information field corresponding with the first segment for display based on and including the data requested from the respective network address.

12. The method of claim 11, wherein the manifest of the content item is modified by associating each segment of the plurality of segments with the respective genre.

13. The method of claim 11, wherein the first segment is associated with a first genre, and
wherein a user selection of the first genre is received at the client computing device.

14. (canceled)

15. The method of 13, further comprising:
identifying a second segment that follows the first segment in the plurality of segments, wherein the second segment is associated with a second genre different from the first genre, and wherein data for the second segment is not requested.

16. The method of claim 15, further comprising:
identifying a third segment that follows the second segment in the plurality of segments, wherein the third segment is associated with the first genre and the second genre;
receiving a second request for data for the third segment from the client computing device;
retrieving the data for the third segment from the database of segments; and
transmitting data for the third segment to the client computing device.

17. The method of claim 11, wherein the data for the first segment is transmitted at a resolution that is higher than a default resolution.

18. The method of claim 11, wherein transmitting the data for the first segment is based at least in part on user profile information related to preferred genre information.

19. The method of claim 11, wherein the preferred genre information comprises at least one of action, romance, song, sad, fight, dialogue, comedy, mystery, narrative, thriller, horror, or humor.

20. The method of claim 11, wherein transmitting the data for the first segment is based at least in part on detecting a change of bandwidth availability or a change of availability in a storage device at the client computing device.

21. The method of claim 1, further comprising generating for display a subsequent segment information field corresponding with a subsequent segment that is associated with and subsequent to the first segment being displayed.

22. The method of claim 11, further comprising generating for display a subsequent segment information field corresponding with a subsequent segment that is associated with and subsequent to the first segment being displayed.
